(19) United States
(12) Patent Application Publication
(10) Pub. No.: US 2012/0098917 A1
(43) Pub. Date: Apr. 26, 2012

(54) IMAGE FORMING APPARATUS

(75) Inventors: Akinori KIMATA, Toyokawa-shi (JP); Masashi SUGANO, Tokyo (JP); Katsunori TAKAHASHI, Tokyo (JP); Akifumi ISOBE, Hidaka-shi (JP); Kenji TAMAKI, Tokorozawa-shi (JP); Satoshi SHIMAO, Tokyo (JP)

(73) Assignee: KONICA MINOLTA BUSINESS TECHNOLOGIES, INC., Tokyo (JP)

(21) Appl. No.: 13/268,099

(22) Filed: Oct. 7, 2011

(30) Foreign Application Priority Data
Oct. 20, 2010 (JP) 2010-235476

(51) Int. Cl. B41J 2/435

(52) U.S. Cl. 347/224

(57) ABSTRACT

Provided is an image forming apparatus to form an image by scanning with a light beam through a polygon mirror, having a motor drive section to rotate and drive the polygon mirror based on a polygon drive clock pulse and an image processing section capable of adjusting image magnification through image processing, and a control section to control that at least image magnification adjustment by changing revolution of the polygon mirror or image magnification adjustment through the image processing in the image processing section is selected in accordance with an output form of the image when the image magnification is adjusted.

This application is based on Japanese Patent Application No. 2010-235476 filed on Oct. 20, 2010, in Japanese Patent Office, the entire content of which is hereby incorporated by reference.

### TECHNICAL FIELD

The present invention relates to an image forming apparatus such as a printer and a copying machine, and in particular to an image forming apparatus having a function to write on a recording medium such as a photoconductive member by scanning with a laser beam from a light source through a polygon mirror.

### BACKGROUND OF THE INVENTION

In the image forming apparatuses such as a laser printer, a copying machine and a facsimile machine using various kinds of electrophotographic methods, the image forming operation is conducted through processes such as charging, exposing, developing, transferring and fixing.

Specifically, an electrostatic latent image of an image to be formed is formed on a surface of a photoconductive drum charged by radiating a light beam (laser beam) which is modulated by image data. Then the electrostatic latent image is developed to be a toner image by a developing device. The toner image is transferred onto a transfer member (recording sheet) via a transfer roller then the toner image is fixed onto the recording sheet with fixing heat in a fixing device.

When the toner image is fixed onto the recording sheet, moisture in the recording sheet is absorbed by the fixing heat and the recording sheet contracts. In particular when two-side image forming is carried out, there occurs a trouble that register marks on an obverse side and a reverse side are displaced each other since images of a first side (obverse side) and a second side (reverse surface) differ in size due to contraction of the recording sheet at fixing of the first side (obverse side).

In the above case, it is possible to match the image sizes of the obverse and reverse side, for example, through a fine adjustment of an image magnification on the reverse side by changing a frequency of a pixel clock pulse as well as revolution of the polygon mirror. The adjustment of the image magnification by changing polygon mirror revolution has a merit that the image quality is not deteriorated however there is a problem that a certain time is required to change the revolution.

Incidentally, other than heat contraction of the recording sheet in the forgoing, an operator may instruct to enlarge or reduce the image size a fraction. The above case can be also addressed by either revolution change of the polygon mirror or by image processing.

For example, the following Patent Documents describe revolution control of the polygon mirror.
Patent Document 1: Unexamined Japanese Patent Application Publication No. 2006-224654
Patent Document 2: Unexamined Japanese Patent Application Publication No. 2006-258946

Incidentally, the polygon mirror is controlled by PLL (Phase Locked Loop) and rotated at a high-speed revolution of several tens of thousands rpm. Further, in case the revolution is changed for the fine adjustment of the image magnification in the above, the certain time (stabilizing time) is required until both the PPL control and the polygon mirror reach to a stable status.

On the other hand, a high speed process is required for recent image forming apparatuses and as a sheet travel distance is shortened in the image forming apparatus, a non-exposing time is also shortened, wherein within the non-exposing time, image forming on the obverse side of the recording sheet is switched to image forming on the reverse side.

Therefore, in the image magnification adjustment by changing revolution of the polygon mirror, if the stabilizing time to change the revolution of the polygon mirror exceeds the above non-exposing time, it is necessary to extend the non-exposing time by reducing the number of the sheets circulating (the number of the sheets circulating in the image forming apparatus at a certain moment) in two-side image forming.

In the above case, for example, if the number of the circulating sheets is reduced from four to three to extend the non-exposing time, productivity is decreased to ¾.

In the technologies described in the Patent Documents 1 and 2, shortening of the above stabilizing time is attempted by optimizing control of the polygon mirror and by cutting waste.

However, along with a demand of increase in productivity of the image forming apparatus, the non-exposing time has been further shortened and since there is a limit on shortening of stabilizing time of the polygon mirror, the stabilizing time of the polygon mirror some times exceeds the non-exposing time depending on the productivity. Thus the stabilizing time of the polygon mirror has been obstructed to increase the productivity.

On the other hand, it is possible to adjust the image magnification by applying image processing on image data without changing revolution of the polygon mirror, however in this method deterioration of image quality was a problem in some cases.

Namely, a method to optimum image quality maintenance (prohibition of image quality deterioration) while increasing productivity (prohibition of decrease in productivity) has not been established.

### SUMMARY

The present invention has one aspect to solve the above problems and an object of the present invention is to provide an image forming apparatus to form an image by scanning with a light beam via a polygon mirror, wherein the image forming apparatus optimizes the productivity and the image quality in the image magnification adjustment.

To achieve the above object, the image forming apparatus to reflect one aspect of the present invention having an image carrier, a light emitting element, a polygon mirror to receive a light beam from the light emitting element, a polygon mirror motor to rotate the polygon mirror and a motor drive section to drive the polygon motor based on a polygon drive clock pulse, includes an exposing section to scan and expose the image carrier with the light beam through the polygon mirror based on image data for forming an electrostatic latent image; a developing section to develop the electrostatic latent image formed by the exposing section on the image carrier with toner to be a toner image; a transfer section to transfer the toner image developed by the developing section on the image carrier onto a recording sheet; an image processing section to adjust an image magnification through image processing; and a control section to selecting at least a first magnification adjustment wherein revolution of the polygon mirror is changed via the motor drive section or a second magnification adjustment wherein the image data is image processed via the image processing section in accordance with an output form of the image, when adjusting image magnification with respect to the recording sheet.

### BRIEF DESCRIPTION OF THE DRAWINGS

FIG. 1 is a block diagram showing a schematic configuration of an embodiment of the present invention.

FIG. 2 is a cross-sectional view showing a schematic configuration of an embodiment of the present invention.

FIG. 3 is a flow chart showing an operation of an embodiment of the present invention.

FIGS. 4a, 4b and 4c are characteristic diagrams of operations of an embodiment of the present invention.

FIG. 5 is a flow chart showing an operation of an embodiment of the present invention.

### DETAILED DESCRIPTION OF PREFERRED EMBODIMENT(S)

An embodiment of an image forming apparatus of the present invention will be described specifically with reference to the drawings.

### [Configuration of Image Forming Apparatus]

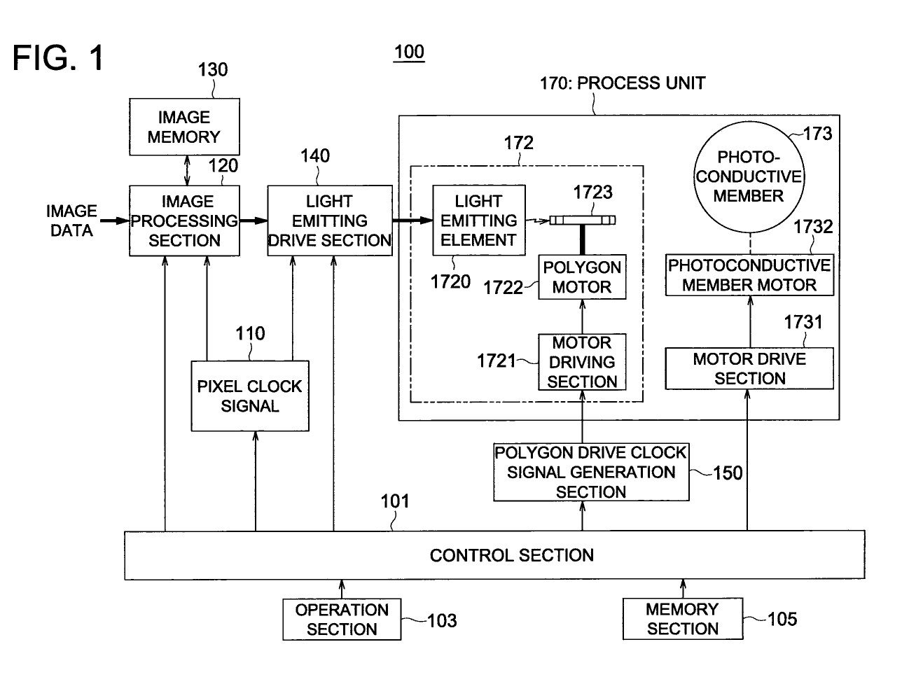

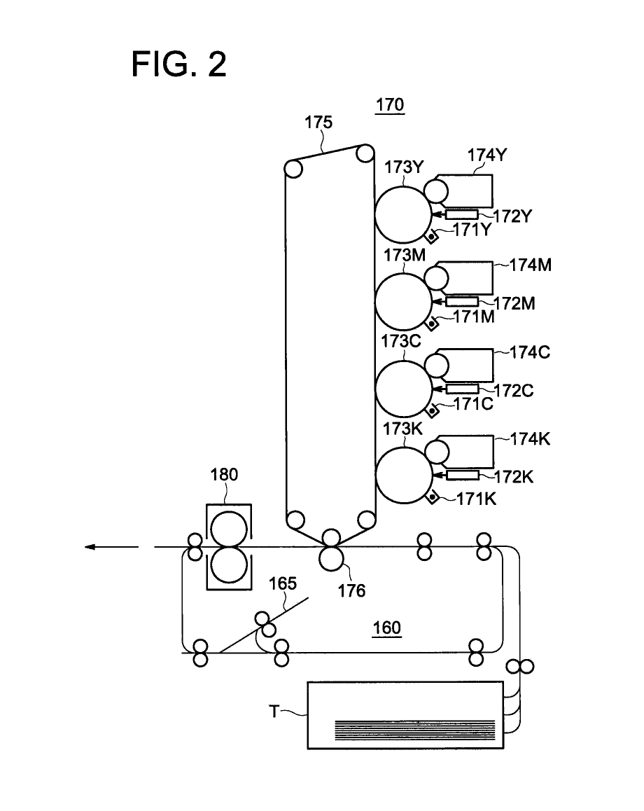

Here, a configuration of an image forming apparatus 100 representing a first embodiment will be described specifically with reference to FIG. 1 (block diagram) and FIG. 2 (cross-sectional view).

Incidentally, explanation of conventional portions as an image forming apparatus which do not directly relate to distinguishing operation and control of the present invention are omitted. In the present embodiment, a direction of moving an image carrier or a conveyance direction of a recording sheet is called a sub-scanning direction. Also, a direction perpendicular to the sub-scanning direction is called a main scanning direction. While conveying the recording sheet in the sub-scanning direction and moving the image carrier in the sub-scanning direction, a two-dimensional image is formed via scanning on the image carried in the main scanning direction, then the image on the image carrier is transferred onto the recording sheet, whereby forming a desired image on the recording sheet.

In the image forming apparatus 100, a control section 101 configured with a CPU and so forth to control each section of the image forming apparatus 100 is operating in accordance with a control program. Incidentally, the control section is characterized by executing control in accordance with a flow chart to be described.

An operation section 103 is to conduct various kids of operations by an operator of the image forming apparatus. Various kids of switches and keys are provided thereon.

A memory section 105, representing a memory device to store various items of data, stores control programs necessary for operating the image forming apparatus and various items of data used to control image forming conditions in the present embodiment.

A pixel clock pulse generation section 110 is a clock pulse generation device to generate a pixel clock pulse used in image processing and exposing for the image data Incidentally, when the image magnification adjustment is conducted by changing revolution of the polygon mirror 1723 via a polygon drive clock pulse generated by a polygon drive clock pulse generation section 150, a frequency of the pixel clock pulse is also changed by the pixel clock pulse generation section.

An image processing section 120 is a processing device to apply image processing onto the image data subject to image forming. In the present embodiment, the image processing section 120 is an image processing device to conduct image processing represented by image magnification adjustment such as enlargement and reduction.

An image memory 130 is a memory device to store the image data to be used as a work memory when the above image processing section 120 conducts the image magnification adjustment.

A light emitting drive section 140 is a drive device to generate an exposing light drive signal in accordance with the image data having been subject to image processing.

A polygon drive clock pulse generation section 150 is a clock pulse generation device to generate a polygon drive clock pulse necessary for rotation drive of the polygon mirror 1723 to be described via a PLL (Phase Lock Loop) control and so forth.

A process unit 170 is a write unit to execute various kinds of operations to form the image (toner image) on the recording sheet provided with an exposing section 172 and a photoconductive member 173.

Here, the exposing section 172 is provided with a light emitting element 1720 such as a laser diode to emit light by receiving an exposing light drive signal from a light emit drive section 140, a motor drive section 1721 to drive a polygon motor 1722 based on a polygon drive clock pulse, a polygon motor 1722 driven by the motor drive section 1721 to rotate the polygon mirror 1723 at a predetermined revolution, and the polygon mirror 1723 rotated by the polygon motor 1722 to scan a surface of the photoconductive member 173 with the light beam from the light emitting element 1720.

The photoconductive member 173, on which the electrostatic latent image is formed by exposing with the light beam and developed as a toner image, is rotated at a given speed by the photoconductive member motor 1723 driven by the motor drive section 1731.

Other configurations of the process unit 170 will be specifically described in FIG. 2. Incidentally, while being omitted in FIG. 1, the process unit and so forth are provided for each color, since the image forming apparatus 100 can perform image forming with a plurality of colors.

Next, mechanical configurations of the image forming apparatus 100 will be described with reference to FIG. 2.

A conveyance section 160 is a conveyance device to convey the recording sheet sent out from the sheet feeding section T at a given conveyance speed, provided with a register roller, other various kinds of conveyance rollers and a conveyance belt. Incidentally, the conveyance section 160 is also provided with a reverse conveyance section 165 which circulates the recording sheet after reversing, when the images are formed on both sides of the recording sheet.

The process unit 170 is a writing unit to execute various kinds of operations to form the image on the recording sheet, provided with a charging section 171 to charge the photoconductive member 173 in a predetermined manner, an exposing section 172 to expose the photoconductive member 173 in accordance with image data, a photoconductive member 173 representing an image carrier where the electrostatic latent image is formed by exposing, a developing section 174 to developed the electrostatic latent image on the photoconductive member 173 to be the toner image, an intermediate transfer member 175 representing an image carrier to carry the toner image which is transferred from the photoconductive member 173 and a transfer section 176 to which the toner image on the intermediate transfer member 175 is transferred.

Incidentally, in the process unit, the charging section 171, the exposing section 172, the photoconductive member 173, and the developing member 174 are respectively disposed corresponding to respective colors. The toner images of respective colors overlaps on the intermediate transfer member 175 and eventually transferred onto the recording sheet.

Incidentally, the photoconductive drum 173 can be in a shape of a belt but not the drum. In the same manner, the intermediate transfer member 175 can be in a shape of a drum but not the belt.

A fixing section 180 performs fixing with heat and pressure to render the toner image stable on the recording sheet while nipping and conveying the recording sheet on which the toner image has been transferred.

### [Operation (1) of Image Forming Apparatus]

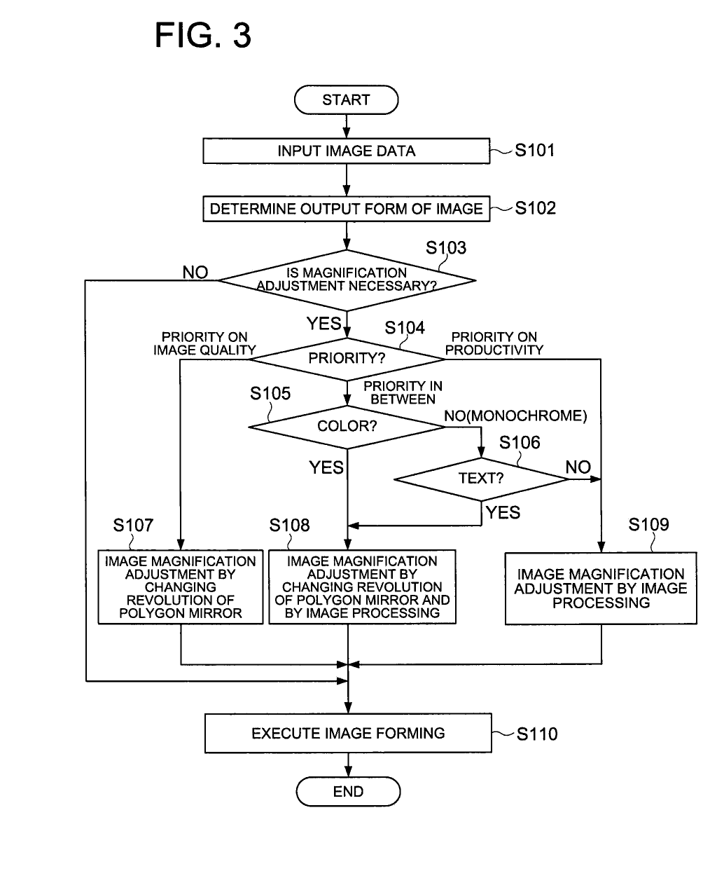

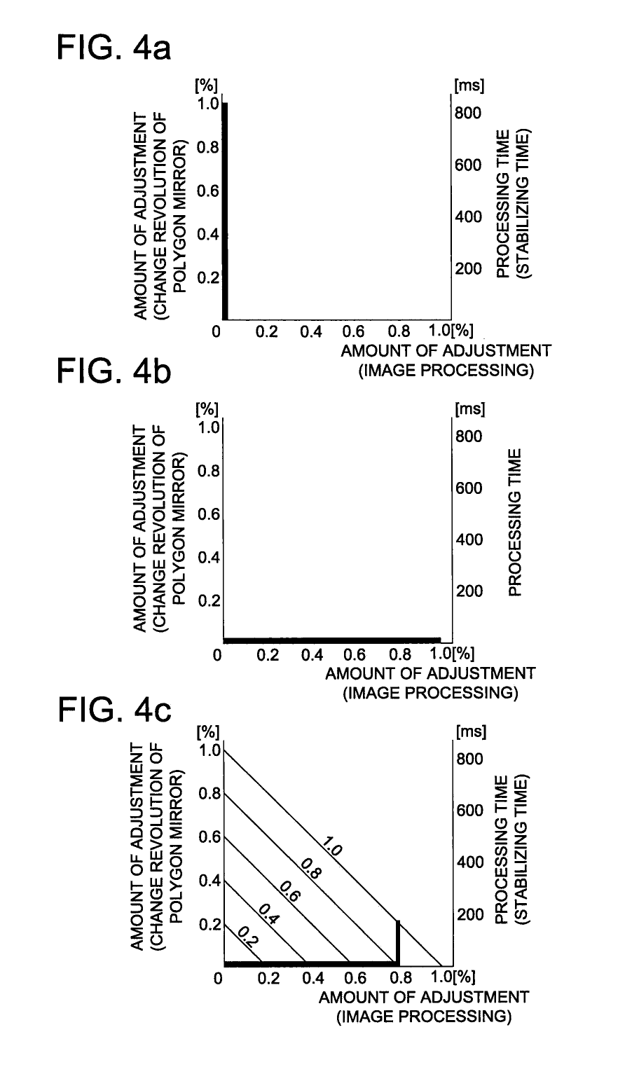

Operation of the image forming apparatus 100 will be described with reference to a flow chart in FIG. 3 and a characteristic diagram in FIG. 4.

Here, the image forming apparatus 100 operates in accordance with a control program of the control section 101. An operation to form basis of the control program is shown in the flow chart in FIG. 3.

First, data subject to image forming is inputted from an external equipment or selected from data stored in an image memory 130 of the image forming apparatus 100 (Step S101 in FIG. 3).

In parallel to the above operation, an operator conducts various settings related to image forming through the operation section 103 (Step S102 in FIG. 3). As the above various settings, the operator also conducts setting for the output form of the image. Here, the output form represents whether priority on image quality or priority on productivity, a monochrome (single color) image or a color (multiple colors) image and a text or a picture, and two-side image forming or one-side image forming. Namely, the output form denotes whether the priority is given to the image quality or the productivity, an image forming mode indicating whether image is formed with single color or multiple colors, kinds of image data indicating whether the image data includes the text or the picture and whether two-side image forming or one-side image forming is conducted.

Here, the control section 101 judges whether or not the image magnification adjustment is necessary (Step S103 in FIG. 3). For example, in case two-side image forming is set or in case the image magnification adjustment is manually inputted by the operator through the operation section, the control section 101 judges that the image magnification adjustment is necessary.

Here, as described in the foregoing, when the toner image is fixed onto the recording sheet, since moisture in the recording sheet is absorbed by the heart of the fixing section 180, the recording sheet contracts. In particular, when two-side image forming is carried out, there occurs a phenomenon that image sizes of a first surface (obverse surface) and a second surface (reverse surface) differ each other due to contraction of the recording sheet at fixing of the first surface (obverse surface). In case the image magnification adjustment is judged to be necessary, since a contraction rate of the recording sheet varies with the kid of the recording sheet, a fixing temperature, and a conveyance speed, the control section 101 refers adjustment amount data stored in the memory section 105 and acquires an adjustment amount corresponding to the kind of the recording sheet and the fixing temperature. Incidentally, in case image magnification adjustment is manually inputted by the operator, an input value from the operation section is acquired as the adjustment value.

In case magnification adjustment is not necessary, (Step S103 in FIG. 3: NO), the control section 101 executes image forming (Step S101 in FIG. 3).

On the other hand, in case magnification adjustment is necessary, (Step S103 in FIG. 3: YES), the control section 101 judges whether “priority on image quality”, “priority on productivity” or “in-between” is selected (Step S104 in FIG. 3).

Here, in case “priority on image quality” is selected as a priority matter, (Step S103 in FIG. 3: priority on image quality), while image magnification adjustment is conducted (Step S107 in FIG. 3) using revolution change of the polygon mirror 1723 via the polygon drive clock created by the polygon drive clock generation section 150, image forming is conducted by control of the control section 101 (Step S110 in FIG. 3). The above case has a characteristic that deterioration of image quality associated with image magnification adjustment does not occur. Incidentally, in case of priority on image quality, as FIG. 4a shows, there is a characteristic that a processing time based on the aforesaid stabilizing time is required in accordance with the amount of magnification adjustment. Thus in case the stabilizing time exceeds the non-exposing period, there will occur a need that the productivity has to be reduced by reducing circulating number of the recording sheets in the conveyance section 160.

In case “priority on the productivity” is selected as the priority matter (Step S103 FIG. 3: priority on the productivity), image magnification adjustment to enlarge or contract the image data via the image processing section 120 is conducted (Step S109 in FIG. 3), then the image forming is carried out via control of the control section 101 (Step S110 in FIG. 3). In the above case, there is a merit that the processing time is not a matter since the image processing is carried out before exposing as FIG. 4b shows. Incidentally, in case of “propriety on productivity”, interpolation or culling of image data is conducted by the image processing, thus there is a characteristic that deterioration of the image quality occur depend on the magnification adjustment amount.

Further, in case “in-between” is selected as the priority matter, (Step S103 in FIG. 3: in-between), which is an intermediate state between “priority on image quality and “priority on productivity”, it has a characteristic that the control section 101 switches between use of either revolution change of the polygon mirror 1723 or image processing of the image processing section 120 and use of both of them in accordance with whether the image to be formed is the monochrome image or the color image (Step S105 in FIG. 3), or text or picture (Step S106 in FIG. 3) so as to enhancing the productivity while minimizing the deterioration of the image.

Here, in case “in-between” is selected as a priority matter (Step S103 in FIG. 3: in-between), in a color image (Step S105 in FIG. 3: YES) color shift is noticeable and in a monochrome image (Step S105 in FIG. 3: NO), if it is a text (Step S106 in FIG. 3: YES), deterioration is noticeable at line portions configuring characters. Therefore, by using revolution change of the polygon mirror 1723 and image processing by the image processing section 120 (Step S108 in FIG. 3), image forming is conducted while adjusting the image magnification and enhancing the productivity wherein deterioration is minimized (Step S110 in FIG. 3).

In case revolution change of the polygon mirror 1723 and image processing by the image processing section 120 are used in combination, as FIG. 4c shows, it is characterized that the range of the magnification amount where deterioration of image quality is low is determined in advance then image magnification adjustment by image processing is conducted for the above range and further, for the magnification adjustment amount exceeding the aforesaid adjustment amount range, the image magnification adjustment by changing revolution of the polygon mirror 1723 is conducted.

Incidentally, in FIG. 4c, an adjustment amount by image processing is represented by a horizontal axis and an adjustment amount by changing revolution of the polygon mirror 1723 is represented by a vertical axis, also the adjustment amount using both is represented by an axis inclining 45 degrees.

FIG. 4c shows an example that the image magnification adjustment is carried out up to an amount of 0.8% in which deterioration of image quality is low for example, and the adjustment amount exceeding the above is addressed by changing revolution of the polygon mirror 1723. In case of FIG. 4c, even if the magnification adjustment amount of 1% is adjusted, the processing time is shorter than that in FIG. 4a.

Here, in case “in-between” is selected as the prior matter (Step S103 in FIG. 3: in-between) and in case of monochrome image (Step S105 in FIG. 3: NO), and if it is not text (Step S106 in FIG. 3: NO), because the deterioration of the image quality is not noticeable, the control section 101 adjusts the image magnification while enhancing the productivity using image processing by the image processing section 120 (Step S109 in FIG. 3) to conduct image forming (Step S110 in FIG. 3).

As above, according to the present embodiment, in the image magnification adjustment in the apparatus to form the image by scanning with a light beam controlled by the polygon mirror, the productivity and the image quality can be selected or controlled optimally.

### [Operation (2) of Image Forming Apparatus]

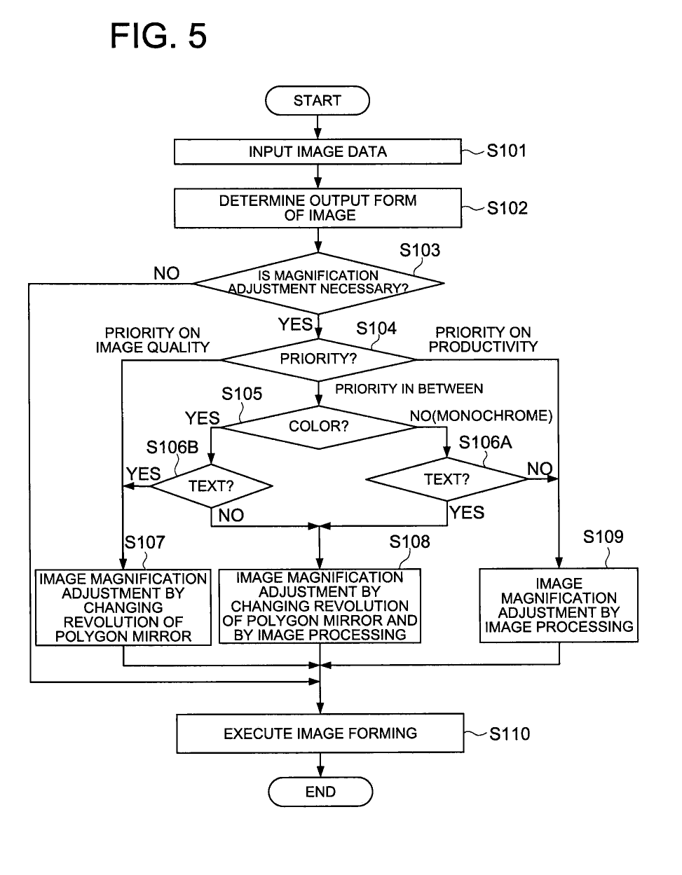

FIG. 5 shows another exemplary operation in the image forming apparatus of the present embodiment. Here, the same operations as in FIG. 3 are denoted by the same step numbers so as to omit duplicated explanations.

Here, in case “in-between” is selected as a prior matter (Step S104 in FIG. 5: YES), and in case of a color image (Step S105 in FIG. 5: YES) which is a text (Step S106B in FIG. 5: YES), since deterioration is noticeable at line portion configuring characters, the control section 101 controls image forming while conducting image magnification adjustment using revolution change of the polygon mirror 1723 via the polygon drive clock generated by the polygon drive clock generation section 150.

Also, in case “in-between” is selected as the prior matter (Step S104 in FIG. 5: in-between), and in case of a color image which is not a text (Step S105 in FIG. 5: YES, Step S106B in FIG. 5: NO) or a monochrome text image (Step S105 in FIG. 5: NO, Step S106A: YES), the control section 101 conducts image forming while conducting image magnification adjustment using both revolution change of the polygon mirror 1723 and image processing of the image processing section 120, whereby the productivity is enhanced while minimizing deterioration of the image quality (Step S110 in FIG. 5).

Also, in case “in-between” is selected as the prior matter (Step S104 in FIG. 5: YES), and in case of a monochrome image (Step S105 in FIG. 5: NO) other than a text image (Step S106A in FIG. 5: NO), since deterioration of the image quality is not noticeable, the control section 101 conducts image forming (Step S110 in FIG. 5) while conducting image magnification adjustment (Step S109 in FIG. 5) by using image processing of the image processing section 120, wherein the productivity is enhanced.

In the present embodiment as well, the productivity and the image quality can be selected or controlled optimally in the image magnification adjustment in the apparatus which forms the image by scanning with the light beam controlled by the polygon mirror.

### Verification of Effect of Embodiment

Effects are verified by applying the above embodiments to a practical image forming apparatus.

In the image forming apparatus used in the verification, a recording sheet conveyance speed was 300 mm/sec, a recording sheets interval was 60 mm, a non-exposing time in the recording sheet interval was 200 m sec and the polygon mirror 1723 rotated at 35,443 rpm in a normal image forming. In case the polygon mirror 1723 was controlled to accelerate by 1%, the stabilizing time was 820 m sec as shown by the vertical axis on right side in FIG. 4a.

Here, in case “priority on image quality” is selected as a priority matter, the image magnification adjustment is conducted using revolution change of the polygon mirror 1723 without using the image processing. In the above case, since the stabilizing time exceeds the non-exposing time, the non-exposing time is extended by reducing the circulation number (number of the recording sheets circulating in the image forming apparatus at a given moment) in two-side image forming, whereby reducing the productivity.

On the other hand, in case of selecting “in-between” as the prior matter, and in case of a color image or a monochrome text image, the image magnification adjustment is conducted using both revolution change of the polygon mirror 1723 and image processing by image processing section 120. For example, in case it is determined in advance that deterioration of the image quality is low up to a magnification adjustment amount of 0.8%, as FIG. 4c shows, magnification adjustment up to the magnification adjustment amount of 0.8% is conducted by image processing and 0.2% is conducted by changing revolution of the polygon mirror 1723, thus the processing time is 160 m sec. Therefore, since the stabilizing time does not exceed the non-exposing time, the productivity is not reduced. Also, since the image processing is used up to the range of the predetermined magnification adjustment amount where the deterioration of the image quality is low, and revolution change of the polygon mirror 1723 is applied to the magnification amount beyond that range, the deterioration of the image quality can be minimized. Incidentally, the values shown here are examples, and various kinds of variations are possible.

As above, according to the embodiment, the productivity and the image quality can be optimally selected or controlled in the image magnification adjustment in the apparatus to form the image by scanning with the light beam through the polygon mirror.

In the present embodiment, in case the image magnification is adjusted, the image forming apparatus is controlled so that at least either change of revolution of the polygon mirror by changing a polygon drive clock or image processing in image processing section is selected in accordance with the output form of the image. Whereby, in the image magnification adjustment in the apparatus to form the image by scanning with the light beam via the polygon mirror, the productivity and the image quality can be optimized with reference to the output form of the image.

What is claimed is:

1. An image forming apparatus, having an image carrier, a light emitting element, a polygon mirror to receive a light beam from the light emitting element, a polygon mirror motor to rotate the polygon mirror and a motor drive section to drive the polygon motor based on a polygon drive clock pulse, comprising:
an exposing section to scan and expose the image carrier with the light beam through the polygon mirror based on image data for forming an electrostatic latent image;
a developing section to develop the electrostatic latent image formed by the exposing section on the image carrier with toner to be a toner image;
a transfer section to transfer the toner image developed by the developing section on the image carrier onto a recording sheet;
an image processing section to adjust an image magnification through image processing; and
a control section to selecting at least a first magnification adjustment wherein revolution of the polygon mirror is changed via the motor drive section or a second magnification adjustment wherein the image data is image processed via the image processing section in accordance with an output form of the image, when adjusting image magnification with respect to the recording sheet.

2. The image forming apparatus of claim 1, wherein the output form represents priority which indicates whether image quality is prior to productivity or the productivity is prior to the image quality.

3. The image forming apparatus of claim 1, wherein the output form represents an image forming mode which indicates whether the image is formed with a single color or with a plurality of colors.

4. The image forming apparatus of claim 1, wherein the output form represents a kind of the image data which indicates whether the image data includes a text or a picture.

5. The image forming apparatus of claim 2, wherein if the output form indicates that a priority is given to the image quality, the control section adjusts the image magnification using the first magnification adjustment and if the output form indicates that the productivity has a priority, the control section adjusts the image magnification using the second magnification adjustment.

6. The image forming apparatus of claim 5, wherein if the output form indicates that a priority is given to between the image quality and the productivity, the control section adjusts the image magnification using both the first magnification adjustment and the second magnification adjustment.

7. The image forming apparatus of claim 6, wherein in case the control section adjust the image magnification using both the first magnification adjustment and the second magnification adjustment, in the second magnification adjustment, the image magnification is adjusted up to a predetermined adjusting amount and in the first magnification adjustment, the image magnification is adjusted by a rest of the adjusting amount of a total adjusting amount.

8. The image forming apparatus of claim 5, wherein if the output form indicates that a priority is given to between the image quality and the productivity, the control section switches between a method that the image magnification is adjusted using both the first and the second magnification adjustment or a method that the image magnification is adjusted using either the first magnification adjustment or the second magnification adjustment, in accordance with the image forming mode or the kid of the image data.

9. The image forming apparatus of claim 1 to form the images on both sides of the recording sheet, wherein the control section conducts the first magnification adjustment in a transitional period from light beam scanning for image forming on one side of the recording sheet to light beam scanning for image forming on another side of the recording sheet.

10. The image forming apparatus of claim 1 to form the images on both sides of the recording sheet, wherein the control section conducts image magnification adjustment for the image formed on one side of the recording sheet and the image formed on another side of the recording sheet.

11. The image forming apparatus of claim 10, wherein the image magnification adjustment is conducted based on a contraction ratio of the recording sheet after the image has been formed on one side of the recording sheet.
